(19) United States
(12) Patent Application Publication
(10) Pub. No.: US 2007/0168284 A1
(43) Pub. Date: Jul. 19, 2007

(54) Management of encrypted storage media

(75) Inventors: Michael E. Factor, Haifa (IL); Dalit Naor, Tel Aviv (IL); Adam Wolman, Hod HaSharon (IL); Aviad Zlotnick, Mitzpeh Netofah (IL)

Correspondence Address: Stephen C. Kaufman;IBM CORPORATION, Intellectual Property Law Dept., P. O. Box 218, Yorktown Heights, NY, 10598, US

(73) Assignee: International Business Machines Corporation, Armonk, NY (US)

(21) Appl. No.: 11/330,409

(22) Filed: Jan. 10, 2006

(51) Int. Cl. G06Q 99/00

(52) U.S. Cl. 705/50

(57) ABSTRACT

A method for use of a physical data storage medium, the method including receiving a first read request for data stored in any of a plurality of storage sub-units on a physical data storage medium, and decrypting the requested data if an indicator associated with the requested data storage sub-unit indicates that data in the requested storage sub-unit is encrypted.

### FIELD OF THE INVENTION

The present invention relates to data storage in general, and more particularly to management of encrypted storage media.

### BACKGROUND OF THE INVENTION

Data stored at a primary data operations site on physical data storage media, such as hard disks, are often copied to other physical data storage media at a point in time, with the copy being transported to a secondary data operations site at a remote location, such as for backup or disaster recovery purposes. Recent incidents involving loss or theft of such copies during transport have highlighted the need for security measures, such as encrypting the data on the copy prior to transport, possibly with multiple encryption keys. Unfortunately, such measures prevent the copy from “going live” at the remote site immediately upon arrival, as current techniques require that the copy be fully decrypted before use. Such a delay is particularly significant where data processing involving the copied data is suspended at the primary site until the secondary site data go live, such as where the data at both sites are to be synchronized with each other. Furthermore, it is often desirable to encrypt data on data storage devices even if the data storage device is not meant to be transported. It would thus be desirable to be able to efficiently determine the encryption state of the data and the keys used to encrypt the data.

### SUMMARY OF THE INVENTION

The present invention discloses a system and method for secure transfer of physical data storage media and use thereof.

In one aspect of the present invention a method is provided for use of a physical data storage medium, the method including receiving a first read request for data stored in any of a plurality of storage sub-units on a physical data storage medium, and decrypting the requested data if an indicator associated with the requested data storage sub-unit indicates that data in the requested storage sub-unit is encrypted.

In another aspect of the present invention the method further includes encrypting the data in the plurality of storage sub-units on the physical data storage medium.

In another aspect of the present invention the encrypting step includes encrypting data in a plurality of the storage sub-units with a plurality of keys.

In another aspect of the present invention the encrypting step is performed at a first physical location, and where the receiving and decrypting steps are performed at a second physical location.

In another aspect of the present invention the method further includes setting an indicator for each of the data storage sub-units indicating if data in the data storage sub-unit is encrypted.

In another aspect of the present invention the method further includes transporting the encrypted physical data storage medium to a second physical location.

In another aspect of the present invention the setting step includes setting the indicator within a vector having a plurality of indices, where each index corresponds to one of the data storage sub-units on the physical data storage medium.

In another aspect of the present invention the method further includes writing the decrypted data to the data storage sub unit and setting the requested data storage sub-unit's indicator to indicate that the data in the requested storage sub-unit are not encrypted.

In another aspect of the present invention the method further includes receiving a second read request for the data stored in the data storage sub-unit for which the first read request was previously received, and providing the previously-decrypted data responsive to the second read request.

In another aspect of the present invention the method further includes reencrypting any of the data with a new key concurrently with performing any of the steps.

In another aspect of the present invention a method is provided for use of a physical data storage medium, the method including encrypting, at a first physical location, data for storage in a plurality of storage sub-units on a physical data storage medium, transporting the encrypted physical data storage medium to a second physical location, receiving a first read request for data stored in any of the data storage sub-units on the encrypted physical data storage medium, and decrypting the requested data if an indicator associated with the requested data storage sub-unit indicates that data in the requested storage sub-unit is encrypted.

In another aspect of the present invention the encrypting step includes encrypting data in the plurality of the storage sub-units with a plurality of keys.

In another aspect of the present invention the method further includes setting an indicator for each of the data storage sub-units indicating if data in the data block is encrypted.

In another aspect of the present invention the method further includes transporting the indicators to the second physical location in association with the encrypted physical data storage medium.

In another aspect of the present invention the setting step includes setting the indicator within a vector having a plurality of indices, where each index corresponds to one of the data storage sub-units on the physical data storage medium.

In another aspect of the present invention the method further includes setting the requested data storage sub-unit's indicator to indicate that the data in the requested storage sub-unit are not encrypted.

In another aspect of the present invention the method further includes receiving a second read request for the data stored in the data storage sub-unit for which the first read request was previously received, and providing the previously-decrypted data responsive to the second read request.

In another aspect of the present invention the method further includes decrypting any of the data concurrently with performing any of the steps and before read requests are received for the data.

In another aspect of the present invention the concurrent decryption step includes decrypting any of the data in storage sub-units adjoining or located in the vicinity of storage sub-units for which read requests were received.

In another aspect of the present invention the method further includes reencrypting any of the data with a new key concurrently with performing any of the steps.

In another aspect of the present invention a system is provided for secure use of physical data storage media, the system including an at least partially encrypted data storage medium storing data in any of a plurality of storage sub-units, a plurality of indicators, each indicator corresponding to one of the storage sub-units and indicating whether data in the storage sub-unit is encrypted, and a storage control unit configured to receive read requests for data stored in one of the storage sub-units on the encrypted data storage medium prior to the data storage medium being decrypted, consult the block's corresponding indicator to determine whether the requested data is encrypted, and decrypt the data if the requested data is encrypted.

In another aspect of the present invention the data in at least two of the storage sub-units are encrypted with different keys.

In another aspect of the present invention the storage control unit is further configured to write the decrypted data to the data storage sub unit and set the requested data storage sub-unit's indicator to indicate that the data in the requested storage sub-unit are not encrypted.

In another aspect of the present invention the storage control unit is further configured to receive a second read request for the data stored in the data storage sub-unit for which the first read request was previously received, and provide the previously-decrypted data responsive to the second read request.

In another aspect of the present invention the storage control unit is further configured to reencrypt any of the data with a new key concurrently with performing any of the steps.

In another aspect of the present invention the storage control unit is further configured to decrypt any of the data concurrently with performing any of the steps and before read requests are received for the data.

In another aspect of the present invention the storage control unit is further configured to decrypt any of the data in storage sub-units adjoining or located in the vicinity of storage sub-units for which read requests were received.

In another aspect of the present invention the system further includes reencrypting any of the data with a new key concurrently with performing any of the steps.

In another aspect of the present invention a computer-implemented program is provided embodied on a computer-readable medium, the computer program including a first code segment operative to receive a first read request for data stored in any of a plurality of storage sub-units on a physical data storage medium, and a second code segment operative to decrypt the requested data if an indicator associated with the requested data storage sub-unit indicates that data in the requested storage sub-unit is encrypted.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a system for secure transfer of physical data storage media and use thereof, constructed and operative in accordance with a preferred embodiment of the present invention;

FIG. 2 is a simplified flowchart illustration of an exemplary method of operation of the system of FIG. 1, operative in accordance with a preferred embodiment of the present invention;

FIG. 3 is a simplified flowchart illustration of an alternate exemplary method of operation of the system of FIG. 1, operative in accordance with a preferred embodiment of the present invention; and

FIG. 4 is a simplified flowchart illustration of a supplemental method of operation of the system of FIG. 1, operative in accordance with a preferred embodiment of the present invention

### DETAILED DESCRIPTION OF PREFERRED EMBODIMENTS

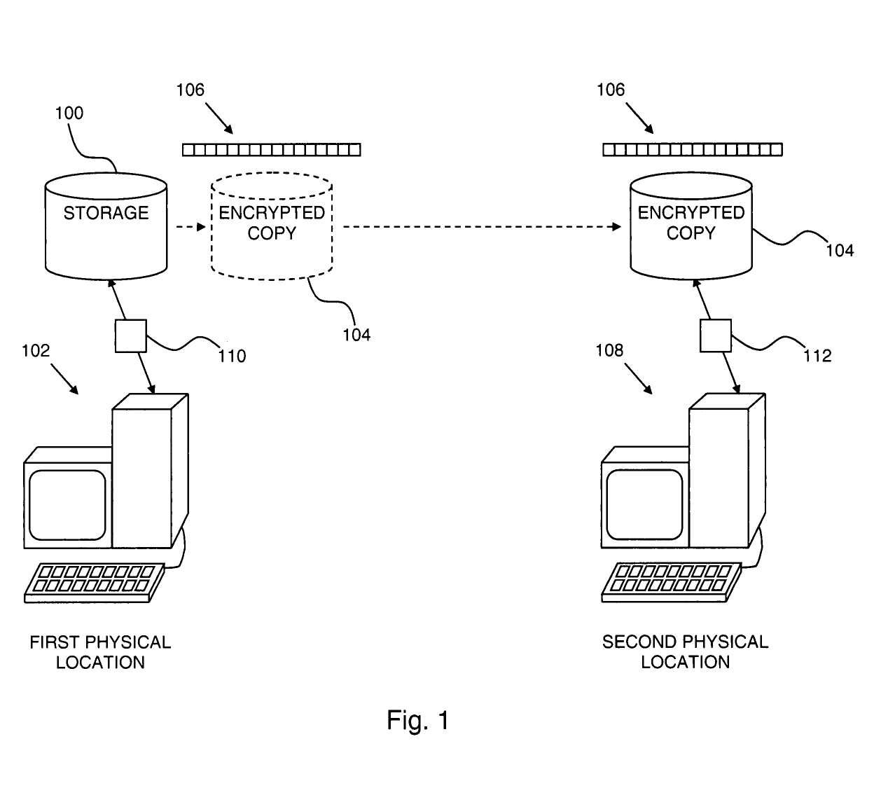

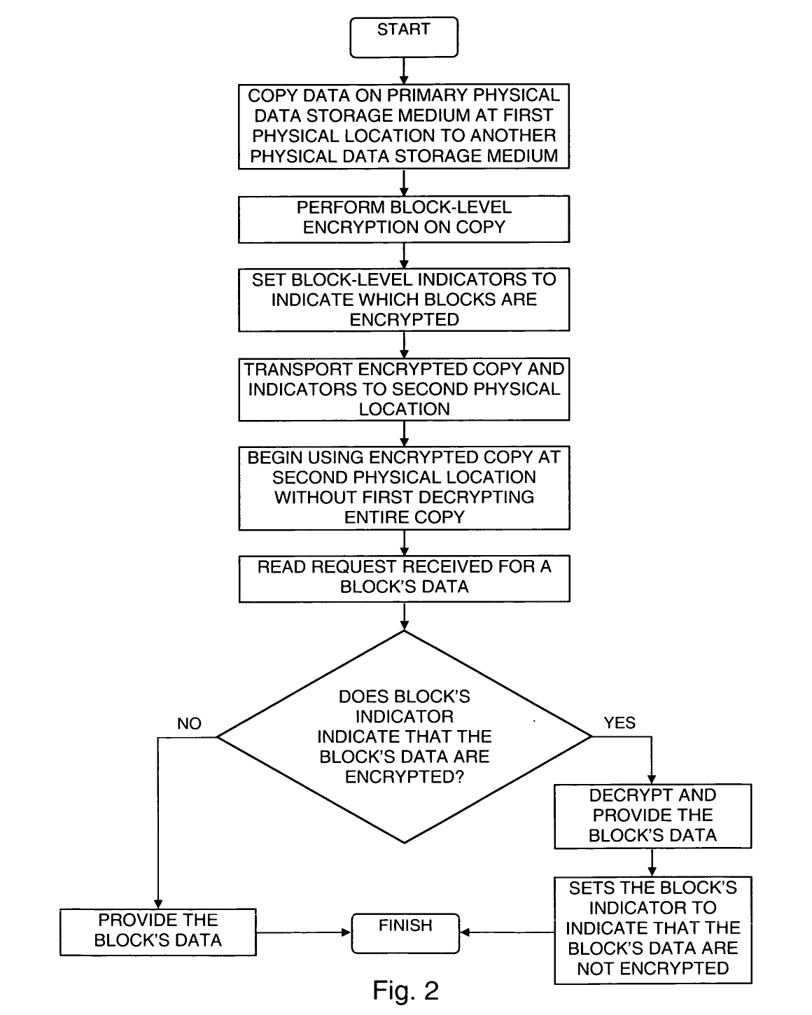

Reference is now made to FIG. 1, which is a simplified conceptual illustration of a system for secure transfer of physical data storage media and use thereof, constructed and operative in accordance with a preferred embodiment of the present invention, and additionally to FIG. 2, which is a simplified flowchart illustration of an exemplary method of operation of the system of FIG. 1, operative in accordance with a preferred embodiment of the present invention. In the system of FIG. 1 and method of FIG. 2, a primary physical data storage medium 100, such as a hard disk of a computer 102, is shown at a first physical location, such as at a primary data operations site. Storage 100 preferably stores data in one or more storage sub-units, such as blocks. A partially or wholly encrypted copy 104 is made of storage 100 by a storage control unit 110 using conventional techniques, where the data stored on storage 100 are read, encrypted, typically at the block level, and written to corresponding blocks in encrypted form to another physical data storage medium. An indicator 106, such as may be represented by an index in a vector of indices, is preferably provided for each block in encrypted copy 104, and is set to indicate whether or not its corresponding block contains encrypted data, such as where indicator 106 is a bit set to a value of one to indicate that the block was encrypted at the time that encrypted copy 104 was prepared, and zero to indicate that the block is not encrypted.

Encrypted copy 104, together with its set of indicators 106, is then transported to a second physical location, such as to a secondary data operations site at a location that is remote from the first location. Alternatively, if it is known that encrypted copy 104 is completely encrypted, it may be transported without indicators 106, as each block may be assumed to be encrypted when reading encrypted copy 104. In marked contrast with prior art techniques, where either an encrypted copy must be completely decrypted before the copied data may “go live” and be used in a production environment, or where data is read and decrypted on every access but left encrypted on the medium, in accordance with the present invention encrypted copy 104 is provided for immediate use, such as by a computer 108 in the form of read/write requests by computer 108's operating system and/or applications executed by computer 108, without encrypted copy 104 first being completely decrypted, and without leaving the data permanently encrypted on the medium and decrypting on every access, thereby reducing the number of decryptions required. A storage control unit 112 is preferably provided for receiving read requests for data stored on encrypted copy 104. When storage control unit 112 first receives a read request for data stored at a particular block on encrypted copy 104, storage control unit 112 consults the block's corresponding indicator 106 to determine whether or not the data stored in the specified block is encrypted. If the data is encrypted, storage control unit 112 decrypts the data. The encryption/decryption of a given block is preferably performed as a function of a key, the location of the block on the storage device, and the block content, but is independent of the plaintext/ciphertext on other blocks. In one embodiment, a single key is used for all encrypted blocks on encrypted copy 104. Any suitable encryption/decryption algorithm may be employed, such as those described in IEEE's P1619 family of standards (see http://www.computer.org/computer/homepage/1124/standards/index.htm). Once the data in an encrypted block have been decrypted, the decrypted data may be written to cache and/or back to the block from which data were read. When the data is written back to the block from which it is read, storage control unit 112 then sets the block's corresponding indicator 106 to indicate that the block's data are not encrypted. Subsequent read requests for data stored at the decrypted block may be serviced by storage control unit 112 with the already-decrypted data, as the block's corresponding indicator 106 indicates that the block's data have already been decrypted. Indeed, where a block's data is already in cache, there is no need to consult the block's corresponding indicator 106 at all, as read request may be satisfied directly from cache. Storage control unit 112 may service write operations on a block whose corresponding indicator 106 indicates that the block's data are encrypted by setting indicator 106 to indicate that the block's data are not encrypted, even where no previous read request was received for the block's data that would have resulted in the data's decryption.

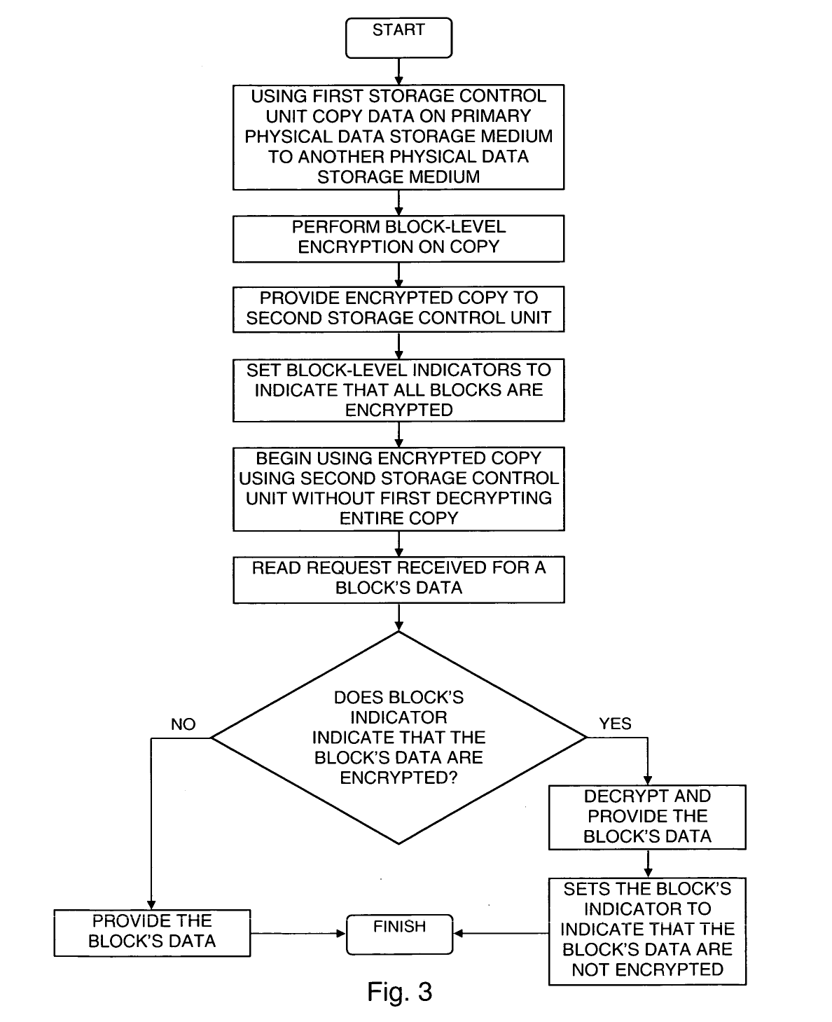

Reference is now made to FIG. 3, which is a simplified flowchart illustration of an alternate exemplary method of operation of the system of FIG. 1, operative in accordance with a preferred embodiment of the present invention. The method of FIG. 3 is substantially similar to the method of FIG. 2, with the notable exception that instead of transporting encrypted copy 104 to a second physical location, encrypted copy 104 is provided for use by storage control unit 112 at the first physical location. Another notable exception, which may also be applied to the method of FIG. 2, is that the set of indicators 106 need not be prepared by storage control unit 110 and provided to storage control unit 112, but may instead be generated by storage control unit 112, where storage control unit 112 is configured to assume that all the storage sub-units on encrypted copy 104 are encrypted and generate the set of indicators 106 accordingly.

The methods of FIGS. 2 and 3 may be further enhanced by storage control unit 112 concurrently running a background process that decrypts encrypted storage sub-units of encrypted copy 104 before read requests are received for their data. Priority may also be given to background decryption of storage sub-units adjoining or located in the vicinity of storage sub-units for which read requests were received, on the assumption that they are more likely to be read than storage sub-units for which read requests were not yet received.

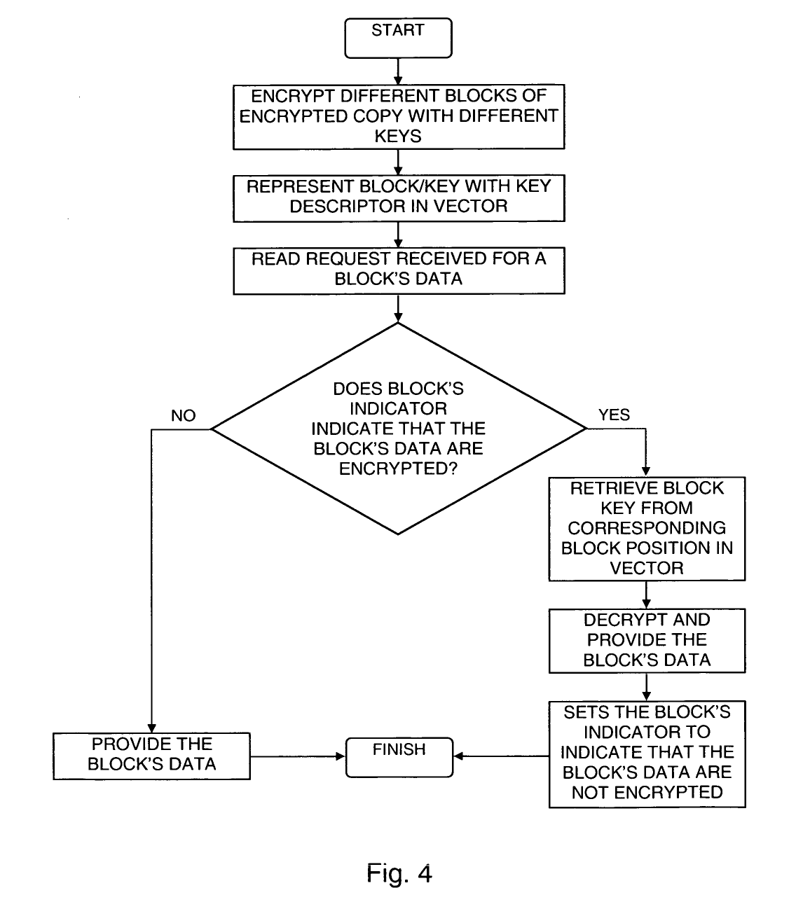

Reference is now made to FIG. 4, which is a simplified flowchart illustration of a supplemental method of operation of the system of FIG. 1, operative in accordance with a preferred embodiment of the present invention. The method of FIG. 4 may be used in conjunction with the methods of FIG. 2 or FIG. 3, where different blocks of encrypted copy 104 may be encrypted with different keys. Indicator 106 in FIG. 1 may be represented by a key-descriptor in a vector that is preferably provided for each block in encrypted copy 104. Indicator 106 is preferably set to indicate whether or not its corresponding block contains encrypted data, such as where indicator 106 is set to a non-zero value i, indicating that the block was encrypted with a key Kᵢ, or a zero to indicate that the block is not encrypted.

During normal operation, when storage control unit 112 receives a read request for data stored at a particular block on encrypted copy 104, storage control unit 112 consults the block's corresponding indicator 106 to determine whether or not the data stored in the specified block is encrypted, and, if so, which key was used. Storage control unit 112 then decrypts the data if necessary, and may be configured to reencrypt the data with either the key with which the data was last encrypted or with a new key, such as during a key refresh procedure, or to leave the data unencrypted. A background task may optionally be provided which re-encrypts any of the data with a new key, such as during periods of low CPU use and/or no disk access, with the background task running concurrently with any methods described hereinabove.

It is appreciated that one more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for use of a physical data storage medium, the method comprising:
receiving a first read request for data stored in any of a plurality of storage sub-units on a physical data storage medium; and
decrypting said requested data if an indicator associated with said requested data storage sub-unit indicates that data in said requested storage sub-unit is encrypted.

2. A method according to claim 1 and further comprising encrypting said data in said plurality of storage sub-units on said physical data storage medium.

3. A method according to claim 2 wherein said encrypting step comprises encrypting data in a plurality of said storage sub-units with a plurality of keys.

4. A method according to claim 2 wherein said encrypting step is performed at a first physical location, and wherein said receiving and decrypting steps are performed at a second physical location.

5. A method according to claim 2 and further comprising setting an indicator for each of said data storage sub-units indicating if data in said data storage sub-unit is encrypted.

6. A method according to claim 2 and further comprising transporting said encrypted physical data storage medium to a second physical location.

7. A method according to claim 5 wherein said setting step comprises setting said indicator within a vector having a plurality of indices, where each index corresponds to one of said data storage sub-units on said physical data storage medium.

8. A method according to claim 1 and further comprising writing said decrypted data to said data storage sub unit and setting said requested data storage sub-unit's indicator to indicate that said data in said requested storage sub-unit are not encrypted.

9. A method according to claim 8 and further comprising:
receiving a second read request for said data stored in said data storage sub-unit for which said first read request was previously received; and
providing said previously-decrypted data responsive to said second read request.

10. A method according to claim 1 and further comprising reencrypting any of said data with a new key concurrently with performing any of said steps.

11. A method for use of a physical data storage medium, the method comprising:
encrypting, at a first physical location, data for storage in a plurality of storage sub-units on a physical data storage medium;
transporting said encrypted physical data storage medium to a second physical location;
receiving a first read request for data stored in any of said data storage sub-units on said encrypted physical data storage medium; and
decrypting said requested data if an indicator associated with said requested data storage sub-unit indicates that data in said requested storage sub-unit is encrypted.

12. A method according to claim 11 wherein said encrypting step comprises encrypting data in said plurality of said storage sub-units with a plurality of keys.

13. A method according to claim 11 and further comprising setting an indicator for each of said data storage sub-units indicating if data in said data block is encrypted.

14. A method according to claim 13 and further comprising transporting said indicators to said second physical location in association with said encrypted physical data storage medium.

15. A method according to claim 11 wherein said setting step comprises setting said indicator within a vector having a plurality of indices, where each index corresponds to one of said data storage sub-units on said physical data storage medium.

16. A method according to claim 11 and further comprising setting said requested data storage sub-unit's indicator to indicate that said data in said requested storage sub-unit are not encrypted.

17. A method according to claim 16 and further comprising:
receiving a second read request for said data stored in said data storage sub-unit for which said first read request was previously received; and
providing said previously-decrypted data responsive to said second read request.

18. A method according to claim 11 and further comprising decrypting any of said data concurrently with performing any of said steps and before read requests are received for said data.

19. A method according to claim 18 wherein said concurrent decryption step comprises decrypting any of said data in storage sub-units adjoining or located in the vicinity of storage sub-units for which read requests were received.

20. A method according to claim 11 and further comprising reencrypting any of said data with a new key concurrently with performing any of said steps.

21. A system for secure use of physical data storage media, the system comprising:
an at least partially encrypted data storage medium storing data in any of a plurality of storage sub-units;
a plurality of indicators, each indicator corresponding to one of said storage sub-units and indicating whether data in said storage sub-unit is encrypted; and
a storage control unit configured to:
receive read requests for data stored in one of said storage sub-units on said encrypted data storage medium prior to said data storage medium being decrypted,
consult said block's corresponding indicator to determine whether said requested data is encrypted, and
decrypt said data if said requested data is encrypted.

22. A system according to claim 21 wherein said data in at least two of said storage sub-units are encrypted with different keys.

23. A system according to claim 21 wherein said storage control unit is further configured to write said decrypted data to said data storage sub unit and set said requested data storage sub-unit's indicator to indicate that said data in said requested storage sub-unit are not encrypted.

24. A system according to claim 23 wherein said storage control unit is further configured to:
receive a second read request for said data stored in said data storage sub-unit for which said first read request was previously received, and provide said previously-decrypted data responsive to said second read request.

25. A system according to claim 21 wherein said storage control unit is further configured to reencrypt any of said data with a new key concurrently with performing any of said steps.

26. A system according to claim 21 wherein said storage control unit is further configured to decrypt any of said data concurrently with performing any of said steps and before read requests are received for said data.

27. A system according to claim 26 wherein said storage control unit is further configured to decrypt any of said data in storage sub-units adjoining or located in the vicinity of storage sub-units for which read requests were received.

28. A system according to claim 21 and further comprising reencrypting any of said data with a new key concurrently with performing any of said steps.

29. A computer-implemented program embodied on a computer-readable medium, the computer program comprising:
a first code segment operative to receive a first read request for data stored in any of a plurality of storage sub-units on a physical data storage medium; and
a second code segment operative to decrypt said requested data if an indicator associated with said requested data storage sub-unit indicates that data in said requested storage sub-unit is encrypted.
